(19) United States
(12) Patent Application Publication
(10) Pub. No.: US 2010/0000546 A1
(43) Pub. Date: Jan. 7, 2010

(54) SAFE JACKET FOR SENIOR AND PATIENT WHO NEED REMEDIAL EXERCISE AND EXERCISING APPARATUS HAVING THE SAME

(76) Inventor: Hong Jae Park, Seoul (KR)

Correspondence Address: IPLA P.A., 3580 WILSHIRE BLVD., 17TH FLOOR, LOS ANGELES, CA, 90010, US

(21) Appl. No.: 12/373,045

(22) PCT Filed: Sep. 26, 2006
(86) PCT No.: PCT/KR06/03819

§ 371 Date: Jan. 8, 2009

(30) Foreign Application Priority Data
Jul. 12, 2006 (KR) 10-2006-0065410

(51) Int. Cl. A61G 15/00; A63B 22/02

(52) U.S. Cl. 128/845; 482/54

(57) ABSTRACT

The present invention provides a safe jacket for seniors and patients who need rehabilitative exercise and an exercising apparatus having the safe jacket, which support a user's body so that the user is securely supported in a walking or exercising space, protect the user's spine, and keep the user's spine straight, thus allowing the user to stand erect and walk while comfortably supporting the user's body. The safe jacket includes a main body which surrounds a user's body and is open at a top, a bottom, and a front thereof. An armpit support is mounted along a groove concavely formed on each of left and right sides of the main body. A plurality of support belts is detachably coupled to either the main body or the armpit support. At least one fastening unit is mounted to the front of the main body, and detachably holds the user's body.

### TECHNICAL FIELD

The present invention relates generally to a safe jacket for seniors and patients who need rehabilitative exercise and an exercising apparatus having the safe jacket. More particularly, the present invention relates to a safe jacket for seniors and patients who need rehabilitative exercise and an exercising apparatus having the safe jacket, which support a user's body so that the user is securely supported in a walking or exercising space, protect the user's spine, and keep the user's spine straight, thus allowing the user to stand erect and walk while comfortably supporting the user's body.

### BACKGROUND ART

In order to lead a healthy life, it is very important that seniors or patients who need rehabilitative exercise conduct regular exercise at a fixed time every day. However, since seniors or patients who need rehabilitative exercise are weak and their bodies are unstable, they may suddenly feel dizzy and fall during such exercise, or may fall when their arms or legs become exhausted.

Recently, a running machine for seniors and patients who need rehabilitative exercise has come onto the market all over the world. The running machine includes handlebars mounted above both sides of a belt track, the belt track slowly moving at a low speed of 0.1 to 0.2 km/h, and a stop button in order to operate the running machine in an emergency. A senior or a patient who needs rehabilitative exercise holds the handlebars mounted to both sides of the running machine, and slowly walks on the belt track, which moves at a low speed. However, when the senior or patient who needs rehabilitative exercise suddenly feels dizzy and falls during the exercise, or his or her arms or legs become exhausted, so that he or she releases the handlebars and falls, it is impossible to effectively cope with this situation. Thus, above all, there is a pressing need for the development of an apparatus for preventing a senior or a patient who needs rehabilitative exercise from falling during exercise and allowing him or her to continue to exercise in a state such that his or her body is securely supported.

Further, a home care system using IT technology has been developed to effectively care for the health of seniors or patients who need rehabilitative exercise. Through the home care system, a physician in charge makes a remote diagnosis, and a senior or patient receives a prescription at home, so that the mental burden and the charge for medical service, which may be incurred when the senior or patient visits a hospital or is in a hospital, can be decreased. By diagnosing, treating, or conducting rehabilitative exercise in the home, the senior or patient can effectively care for his or her health.

However, in order to activate the home care system, an exercising apparatus or a protecting apparatus for allowing a senior or a patient to safely and easily exercise or conduct rehabilitative exercise without the help of a caregiver is required. Because of this practical demand, the development of an exercising apparatus or a protecting apparatus for helping a user conduct various kinds of exercises and rehabilitative exercise while safely and comfortably supporting a user's body is urgent.

Meanwhile, in order to prevent an accident while a senior or a patient who needs rehabilitative exercise conducts exercise, and allow a user to continue exercising, Korean Patent Appln. No. 10-2006-16604 (Device for Helping Walking for Seniors and Patients Who Need Rehabilitative Exercise) was filed by the applicant of the present invention. The walking helping device according to the cited document is provided with a safe support unit for supporting a user's body and safely catching his or her body when the senior or the patient who needs rehabilitative exercise conducts exercise and falls. However, the safe support unit is problematic in that it is difficult for a senior who is disabled or a patient who needs rehabilitative exercise to easily put on the safe support unit. Further, since cushions are not provided in armpit supports, the armpit supports strongly press a user's arm pits when an accident, such as a fall, occurs, thus causing pain.

### DISCLOSURE OF INVENTION

### Technical Problem

Accordingly, the present invention has been made keeping in mind the above problems occurring in the prior art, and an object of the preset invention is to provide a safe jacket for seniors and patients who need rehabilitative exercise and an exercising apparatus having the safe jacket, in which a comfortable and soft cushion is attached to an armpit belt, thus relieving pain in an armpit region supporting a user's body, and which is easy for a user to put on, protect the spine, keep the body erect, and bear his or her weight, in addition to allowing him or her to comfortably conduct various kinds of exercises.

Another object of the preset invention is to provide a safe jacket for seniors and patients who need rehabilitative exercise and an exercising apparatus having the safe jacket, which allow the seniors or patients to safely and comfortably walk or conduct rehabilitative exercise at home without the help of a caregiver.

### Technical Solution

In order to accomplish the objects, the present invention provides a safe jacket for seniors and patients who need rehabilitative exercise, including a main body surrounding a user's body, and being open at a top, a bottom, and a front thereof; an armpit support mounted along a groove concavely formed on each of left and right sides of the main body, and supporting the user's body; a plurality of support belts detachably coupled to either the main body or the armpit support; and at least one fastening unit mounted to the front of the main body, and detachably holding the user's body.

The main body further has on a lower portion thereof a plurality of subsidiary support belts, with a spinal band being detachably attached to a lower end of the main body.

A shock absorbing part is mounted to an upper surface of the armpit support.

The main body includes a frame defining a basic framework, and a covering surrounding an outer surface of the frame.

The frame comprises a plurality of vent holes, and the covering comprises either a net having a plurality of vent holes or a shock absorbing part having a cushioning effect.

A shock absorbing material is interposed between the frame and the covering.

The support belts comprise four or more support belts, the subsidiary support belts comprise four or more subsidiary support belts, and the support belts and the subsidiary support belts are mounted to a frame of an exercising apparatus to be parallel to each other.

According to the first embodiment, the present invention provides an exercising apparatus for seniors and patients who need rehabilitative exercise, including a safe jacket having a main body surrounding a user's back and flanks, an armpit support mounted along a groove concavely formed on each of left and right sides of the main body, and supporting the user's arm pit, a plurality of support belts detachably coupled to either the main body or the armpit support, and at least one fastening unit mounted to the front of the main body, and detachably holding the user's body; and a frame having a plurality of locking protrusions so that the plurality of support belts is detachably coupled to the locking protrusions.

The safe jacket further has on a lower portion thereof a plurality of subsidiary support belts, with a spinal band detachably attached to a lower end of the main body.

According to the second embodiment, the present invention provides an exercising apparatus for seniors and patients who need rehabilitative exercise, including a safe jacket having a main body surrounding a user's back and flanks, an armpit support mounted along a groove concavely formed on each of left and right sides of the main body and supporting the user's armpit, a plurality of support belts detachably coupled to either the main body or the armpit support, and at least one fastening unit mounted to a front of the main body, and detachably holding the user's body; a plurality of columns vertically mounted to a base plate; a pair of guide rails mounted to be supported in a horizontal direction via the plurality of columns; and a moving unit moving along the guide rails, the safe jacket being detachably coupled to the moving unit via the plurality of support belts.

The moving unit includes a movable part having a plurality of rollers which are rotatably mounted; a rotary part rotatably mounted under the movable part, and having a plurality of locking protrusions so that the support belts of the safe jacket are detachably coupled to the locking protrusions; and a handle frame provided on a lower portion of the rotary part.

The safe jacket further has a plurality of subsidiary support belts on a lower portion of the main body, with a spinal band being detachably attached to a lower end of the main body.

### Advantageous Effects

The present invention is mounted to various kinds of exercising apparatuses used by seniors or patients, thus preventing an accident, that is, preventing a user from falling, and allowing him or her to safely continue to exercise, therefore allowing seniors or patients who need rehabilitative exercise to lead a healthy life.

Further, the present invention provides a safe jacket for seniors and patients who need rehabilitative exercise, which is easy for a user to put on, and attaches a comfortable and soft cushion to an armpit support, thus decreasing the pain experienced in an armpit region supporting his or her body when an accident occurs.

The present invention is easy for a user to put on, has a comfortable and soft cushion attached to an armpit support, thus relieving pain around an armpit region supporting his or her body, protects the spine, keeps the body erect, bears his or her weight, allows the user to comfortably exercise his or her whole body, and allows a senior who has had an artificial knee installed due to degenerative arthritis and a patient having a ruptured spinal disc to safely and easily conduct walking exercise for his or her whole body.

Further, the present invention allows a senior or a patient who needs rehabilitative exercise to safely and comfortably walk or conduct rehabilitative exercise at home without the help of a caregiver, thus promoting a home care system.

### BRIEF DESCRIPTION OF THE DRAWINGS

FIG. 1 is a perspective view showing a safe jacket for seniors and patients who need rehabilitative exercise, according to the first embodiment of the present invention;

FIG. 2 is a sectional view taken along line II-II of FIG. 1;

FIG. 3 is a view showing the state where the safe jacket for seniors and patients who need rehabilitative exercise, according to the first embodiment of the present invention, is mounted to an exercising apparatus, and a user exercises using the safe jacket;

FIG. 4 is a perspective view showing a safe jacket for seniors and patients who need rehabilitative exercise, according to the second embodiment of the present invention;

FIG. 5 is a view showing the state where the safe jacket, according to the second embodiment of the present invention, is mounted to an exercising apparatus and a user exercises using the exercising apparatus;

FIG. 6 is a perspective view showing a rail-type exercising apparatus to which the safe jacket, according to the first or second embodiment of the present invention, is mounted;

FIG. 7 is a perspective view showing a moving unit of the rail-type exercising apparatus, according to the present invention;

FIG. 8 is a sectional view showing portion A of FIG. 7; and

FIG. 9 is a side view showing the rail-type exercising apparatus, according to the present invention.

### MODE FOR THE INVENTION

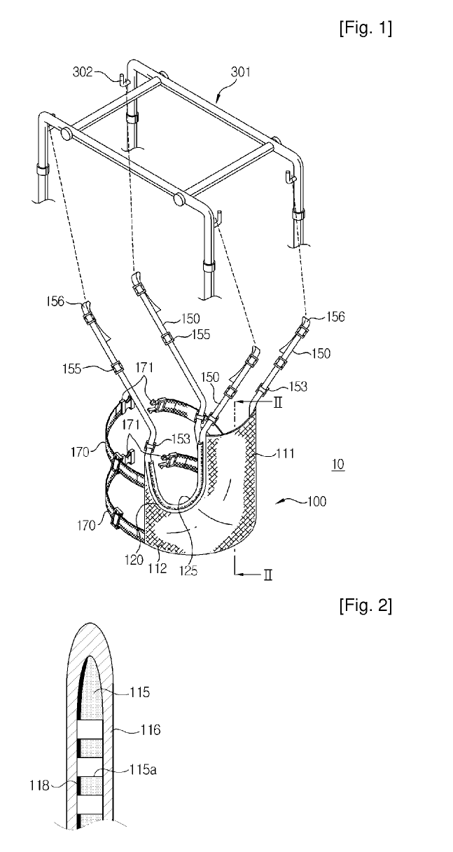

FIGS. 1 to 3 show a safe jacket 10 for seniors and patients who need rehabilitative exercise, according to the first embodiment of the present invention.

As shown in the drawings, the safe jacket 10 for seniors and patients who need rehabilitative exercise, according to the present invention, includes a main body 100 which surrounds a user's back and flanks, armpit supports 120 which support both armpits of the user and support the user's body when an accident occurs, a shock absorbing part 125 which is attached to the upper portion of each armpit support 120, and a plurality of support belts 150 which are detachably coupled to ends of both armpit supports 120 via coupling loops 153.

The main body 100 is open at the top, the bottom, and the front thereof, and is shaped to safely surround a user's back and flanks. That is, the main body 100 includes a back support part 111 which surrounds a user's back, and flank support parts 112 which are provided on opposite sides of the back support part 111 and are bent to extend forwards.

Further, at least one fastening unit 170 may be provided on the front of the body 100 to detachably hold a user's body. Various types of attachment means 171, such as a buckle or Velcro Fastener, may be provided on ends of the fastening unit 170.

As shown in FIG. 2, the main body 100 includes a frame 115 which defines a basic framework, and a covering 116 which covers the outer surface of the frame 115.

The frame 115 is made of a material having a predetermined rigidity, such as synthetic resin, to define the basic framework of the main body 100, and is formed to surround the main body. Further, a plurality of vent holes 115 a is formed in the frame 115, and the covering 116 may comprise a shock absorbing material having a cushioning effect, such as a net and/or a sponge having a plurality vent holes, so that the covering surrounds the outer surface of the frame 115 while affording good air permeability and a good feeling when the safe jacket is worn. A shock absorbing material 118, such as a sponge, may be provided on a portion of the frame 115 which is adjacent to a user's body.

Further, the frame 115 may be constructed so that frame parts corresponding to the back support part 111 and the flank support parts 112 of the main body 100 are separated from each other. Alternatively, the frame may have an integral-type structure.

The left and right armpit supports 120 are provided on the upper portions of the flank support parts 112, and have the shape of a concave groove, thus allowing the body to be more firmly and safely supported through the armpits. Each armpit support parts 120 may comprise a belt-shaped sheet.

The support belt 150 is directly connected to each end of the armpit supports 120 via the coupling loop 153, thus more stably supporting a user's body.

Preferably, the shock absorbing part 125 having the cushioning effect is mounted to the upper surface of each armpit support 120, thus mitigating shocks acting on each arm pit when an accident occurs during exercise.

The lower end of each of the support belts 150 is detachably coupled to the end of each of the left and right armpit supports 120 via the coupling loop 153. The upper end of each support belt 150 has a locking hole 156, so that the support belt is detachably coupled to a frame 301 of an exercising apparatus 300, such as a running machine, a step machine, or a stationary bicycle. Particularly, the locking holes 156 of the support belts 150 may be detachably fitted over locking protrusions 302 which are provided on the frame 301.

Further, each support belt 150 may be provided with an adjusting unit 155. Various adjusting means, such as a tri glide, with which the length of the support belt 150 can be easily adjusted and fixed, may be used as the adjusting unit 155. A user adjusts and fixes the length of the support belt 150 according to his or her height, using the adjusting unit 155, so that he or she can exercise comfortably and safely.

Meanwhile, it is preferable that the support belt 150 comprise four or more support belts.

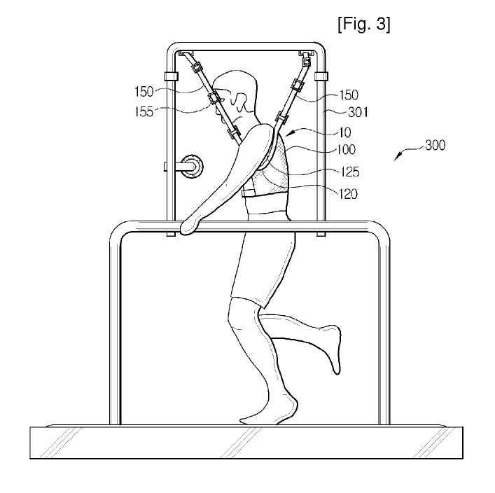

That is, as shown in FIG. 3, the safe jacket 10 according to the first embodiment can be supported at four or more points on the frame 301 of the exercising apparatus 300 by the four or more support belts 150. Thus, such a construction allows a user's body to be more stably supported, prevents him or her from falling, and allows him or her to continue exercising in a stable position, when an accident occurs while a user uses the exercising apparatus 300.

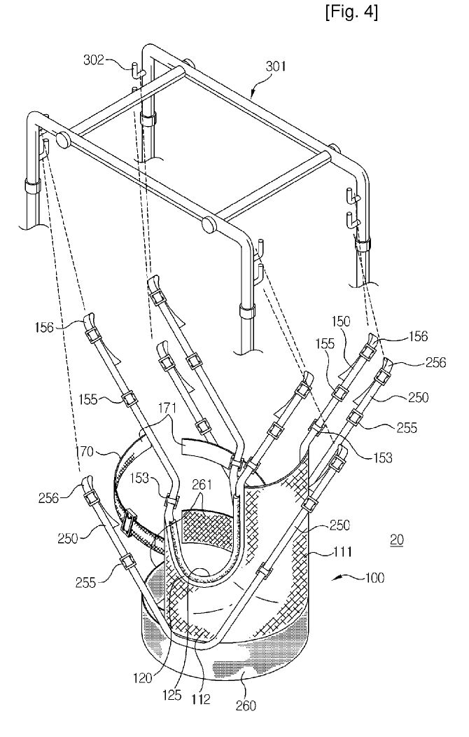

FIG. 4 is a view showing a safe jacket 20 for seniors and patients who need rehabilitative exercise, according to the second embodiment of the present invention.

As shown in the drawing, the safe jacket 20 of the second embodiment has a plurality of subsidiary support belts 250 on the lower portion of a main body 100. A spinal band 260 is detachably coupled to the lower end of the main body 100.

The lower end of each subsidiary support belt 250 may be detachably attached to the main body 100 and/or the spinal band 260. A locking hole 256 is provided on the upper end of each subsidiary support belt 250, so that the subsidiary support belt is detachably coupled to the frame 301 of an exercising apparatus 300, such as a running machine, a step machine, or a stationary bicycle. Especially, the locking holes 256 may be detachably fitted over corresponding locking protrusions 302 which are provided on the frame 301.

Further, each subsidiary support belt 250 may be provided with an adjusting unit 255. Various adjusting means, such as a tri glide, which easily adjusts and fixes the length of the support belt 150, may be used as the adjusting unit 255. A user adjusts and fixes the length of the subsidiary support belt 250 according to his or her height, using the adjusting unit 255, so that he or she can exercise comfortably and safely.

Meanwhile, it is preferable that the subsidiary support belt 250 comprise four or more belts.

Further, the plurality of subsidiary support belts 250 and the plurality of support belts 150 are coupled to the frame 301 of the exercising apparatus 300 so as to be parallel to each other, thus more stably supporting a user's body.

The spinal band 260 is worn around a user's waist. Thereafter, the two ends of the spinal band 260 are attached to each other via attachment means 261, such as a buckle or a Velcro Fastener, so that the spinal band is secured around the user's body, thus compressing and protecting his or her spine.

The spinal band 260 is made of a material having rigidity and elasticity sufficient to compress and protect a user's spine. A cushion may be attached to the inner surface or outer surface of the spinal band.

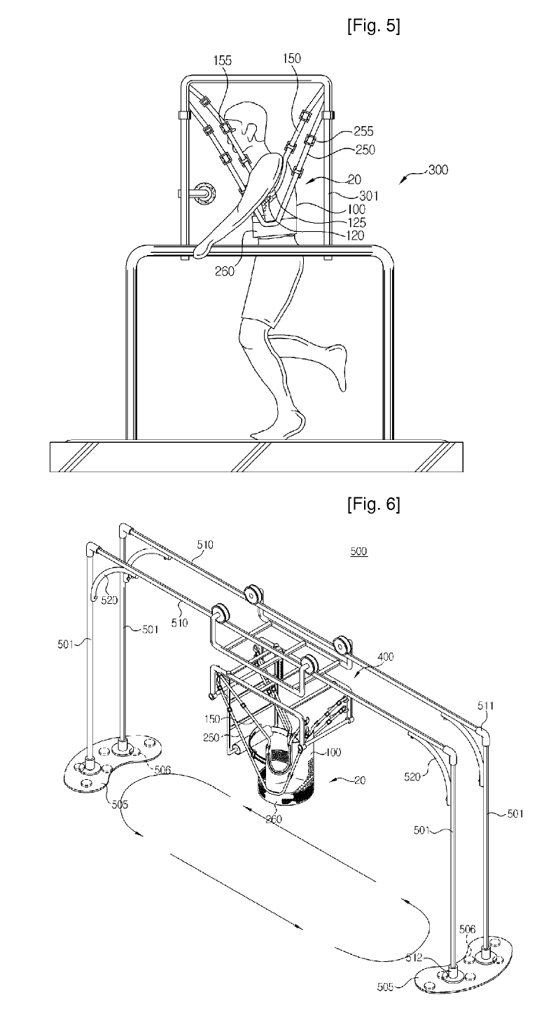

According to the second embodiment, as shown in FIG. 5, the safe jacket 10 is supported at 8 or more points on the frame 301 of the exercising apparatus 300 through the plurality of support belts 150 and subsidiary support belts 250, and a user's spine is compressed by the spinal band 260. Such a construction allows a user's body to be more stably supported and continue exercising in a more stable position, when an accident occurs while he or she uses the exercising apparatus 300.

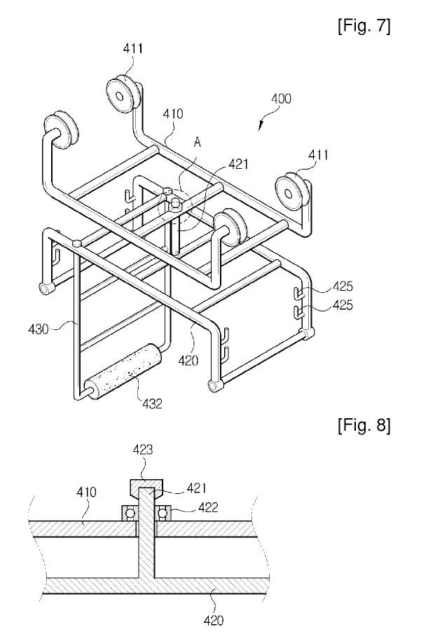

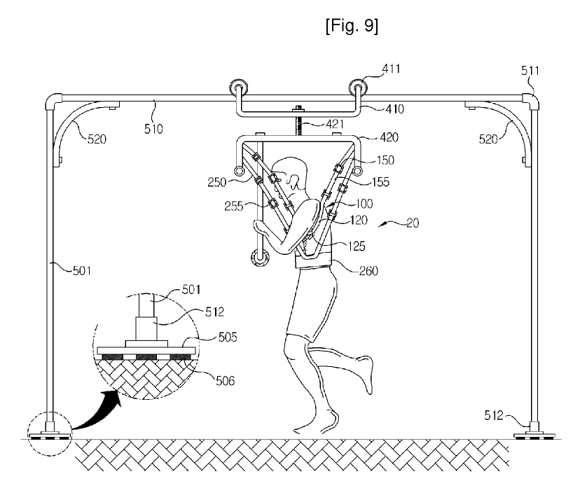

FIGS. 6 to 9 show a rail-type exercising apparatus 500 to which the safe jacket 10 or 20 according to the first or second embodiment of the present invention is mounted, thus allowing a senior or a patient who needs rehabilitative exercise to safely stand up and walk.

As shown in the drawings, the rail-type exercising apparatus 500 of the present invention includes base plates 505, a plurality of columns 501 which are vertically mounted to the base plates 505, a pair of guide rails 510 which are installed to be supported in a horizontal direction via the plurality of columns 501, a moving unit 400 which moves along the guide rails 510, and the safe jacket 10 or 20 which is detachably coupled to the moving unit 400 via the plurality of support belts 150 and/or the plurality of subsidiary support belts 250.

The base plates 505, the columns 501, and the guide rails 510 may be detachably coupled to each other via coupling members, including elbows 511 and flanges 512. Thus, the rail-type exercising apparatus 500 of the present invention is advantageous in that it is convenient to store and use in a home.

Meanwhile, reinforcing members 520 are further provided at junctions of the columns 501 and the guide rails 510 to increase supporting strength. Particularly, since the reinforcing members 520 prevent the guide rails from bending when the length of each guide rail 510 is increased, the length of each guide rail 510 can be further increased.

Moreover, each base plate 505 may have a “U” shape to more stably support the rail-type exercising apparatus 500.

Further, shock absorbing members 506, such as a cushion, may be further provided on the lower surface of each base plate 505, thus supporting the base plate 505 while absorbing shocks.

The moving unit 400 includes a movable part 410 which moves along the guide rails 510, a rotary part 420 which is rotatably installed under the movable part 400, and a handle frame 430 which is mounted to the lower portion of the rotary part 420.

A plurality of rollers 411 is rotatably mounted to the upper portion of the movable part 410. Each roller 411 performs a rolling motion along the guide rails 510.

The rotary part 420 is rotatably mounted to the movable part 410 via a shaft 421. A bearing 422 is fitted over the outer circumference of the shaft 421, and a locking nut 423 is fastened to the upper end of the shaft 421.

Further, a plurality of locking protrusions 425 is provided on a predetermined portion of the rotary part 420. Ends of the support belts 150 and/or the subsidiary support belts 250 of the safe jacket 10 or 20 are detachably coupled to the locking protrusions 425.

The handle frame 430 has the shape of a ladder and is detachably coupled to the lower portion of the rotary part 420. A shock absorbing part 432, such as a roll cushion, may be mounted to the lower end of the handle frame.

A user wears the safe jacket 10 or 20 in the state where the ends of the support belts 150 and/or the subsidiary support belts 250 of the safe jacket 10 or 20 according to the first or second embodiment of the present invention are coupled to the locking protrusions 425 of the rotary part 420.

Thereafter, while the user is stably supported by the safe jacket 10 or 20, he or she can conduct walking motion along the guide rails 510 with his or her spine erect.

1. A safe jacket for seniors and patients who need rehabilitative exercise, comprising:
a main body surrounding a user's body, and being open at a top, a bottom, and a front thereof;
an armpit support mounted along a groove concavely formed on each of left and right sides of the main body, and supporting the user's body;
a plurality of support belts detachably coupled to either the main body or the armpit support; and
at least one fastening unit mounted to the front of the main body, and detachably holding the user's body.

2. The safe jacket according to claim 1, wherein the main body further comprises on a lower portion thereof a plurality of subsidiary support belts, with a spinal band being detachably attached to a lower end of the main body.

3. The safe jacket according to claim 1, wherein a shock absorbing part is mounted to an upper surface of the armpit support.

4. The safe jacket according to claim 3, wherein the main body comprises a frame defining a basic framework, and a covering surrounding an outer surface of the frame.

5. The safe jacket according to claim 4, wherein the frame comprises a plurality of vent holes, and the covering comprises either a net having a plurality of vent holes or a shock absorbing part having a cushioning effect.

6. The safe jacket according to claim 5, wherein a shock absorbing material is interposed between the frame and the covering.

7. The safe jacket according to claim 1, wherein the support belts comprise four or more support belts, the subsidiary support belts comprise four or more subsidiary support belts, and the support belts and the subsidiary support belts are mounted to a frame of an exercising apparatus to be parallel to each other.

8. An exercising apparatus for seniors and patients who need rehabilitative exercise, comprising:
a safe jacket, comprising:
a main body surrounding a user's back and flanks;
an armpit support mounted along a groove concavely formed on each of left and right sides of the main body, and supporting the user's arm pit;
a plurality of support belts detachably coupled to either the main body or the armpit support; and
at least one fastening unit mounted to the front of the main body, and detachably holding the user's body; and
a frame having a plurality of locking protrusions so that the plurality of support belts is detachably coupled to the locking protrusions.

9. The exercising apparatus according to claim 8, wherein the safe jacket further comprises on a lower portion thereof a plurality of subsidiary support belts, with a spinal band detachably attached to a lower end of the main body.

10. An exercising apparatus for seniors and patients who need rehabilitative exercise, comprising:
a safe jacket, comprising:
a main body surrounding a user's back and flanks;
an armpit support mounted along a groove concavely formed on each of left and right sides of the main body, and supporting the user's armpit;
a plurality of support belts detachably coupled to either the main body or the armpit support; and
at least one fastening unit mounted to a front of the main body, and detachably holding the user's body;
a plurality of columns vertically mounted to a base plate;
a pair of guide rails mounted to be supported in a horizontal direction via the plurality of columns; and
a moving unit moving along the guide rails, the safe jacket being detachably coupled to the moving unit via the plurality of support belts.

11. The exercising apparatus according to claim 10, wherein the moving unit comprises:
a movable part having a plurality of rollers which are rotatably mounted;
a rotary part rotatably mounted under the movable part, and having a plurality of locking protrusions so that the support belts of the safe jacket are detachably coupled to the locking protrusions; and
a handle frame provided on a lower portion of the rotary part.

12. The exercising apparatus according to claim 10, wherein the safe jacket further comprises a plurality of subsidiary support belts on a lower portion of the main body, with a spinal band being detachably attached to a lower end of the main body.

13. The safe jacket according to claim 2, wherein the support belts comprise four or more support belts, the subsidiary support belts comprise four or more subsidiary support belts, and the support belts and the subsidiary support belts are mounted to a frame of an exercising apparatus to be parallel to each other.
